(19) United States
(12) Patent Application Publication
(10) Pub. No.: US 2017/0175924 A1
(43) Pub. Date: Jun. 22, 2017

(54) Valve Piston, and Slide Valve having a Valve Piston

(71) Applicant: Robert Bosch GmbH, Stuttgart (DE)

(72) Inventors: Daniel Gerlach, Lohr Am Main (DE); Klaus Habr, Marktheidenfeld (DE)

(21) Appl. No.: 15/381,411

(22) Filed: Dec. 16, 2016

(30) Foreign Application Priority Data
Dec. 18, 2015 (DE) 10 2015 225 927.7

(51) Int. Cl. F16K 31/122; F16K 47/04; F16K 15/02

(52) U.S. Cl. CPC F16K 31/1223; F16K 15/021; F16K 47/04

(57) ABSTRACT

A valve piston includes a section that has a circular-cylindrical configuration with a constant diameter. A plurality of longitudinal grooves are made in the section with the grooves parallel to one another and distributed uniformly on the circumference. The remaining webs enable the section of the valve piston to be moved in the valve without tilting. Each longitudinal groove has one steeper flank and one less steep flank. The steeper flank is set against a pressure medium that flows in. A slide valve includes the valve piston.

This application claims priority under 35 U.S.C. §119 to patent application no. DE 10 2015 225 927.7, filed on Dec. 18, 2015 in Germany, the disclosure of which is incorporated herein by reference in its entirety.

### BACKGROUND

The disclosure relates to a valve piston and to a slide valve having the valve piston.

Valve pistons for slide valves are known from the prior art, which valve pistons have a radial step which is formed by way of a piston collar and a piston section which is reduced in size radially with respect to the latter. A circumferential piston-side control edge is formed on the step. In the installed state of the valve piston in a valve housing and during operation of the valve which is formed in this way, the piston-side control edge is displaced relative to a circumferential control edge of the valve housing. In this way, a circumferential annular opening is opened and its size is set, or the annular opening is reduced in size and finally closed in the case of a displacement of the valve piston in the opposite direction.

Documents U.S. Pat. No. 2,747,612 and U.S. Pat. No. 4,923,172 disclose valves, the valve pistons of which do not have a radial step. Instead, a circumferential piston neck is formed axially between two regions of the piston with an identical diameter. In the case of valves having valve pistons of this type, the flow enters radially inward into the piston neck and afterward exits radially from the piston neck. To this end, a shape of the piston neck which is adapted to the said flow is proposed.

It is a disadvantage of the said valve pistons that, during a movement of the piston into a closed position of the valve, the circumferential edge of the piston has to be pushed under or into a circumferential control edge of the housing, which results in very high requirements for the fit accuracy and the coaxial guidance of the piston.

In contrast, the disclosure is based on the object of providing a valve piston, on which a flow can be guided in and out between its two regions which are spaced apart axially from one another, it being possible for the valve piston to be displaced securely and without tilting in a housing of a relevant valve.

### SUMMARY

The object is achieved by way of a valve piston having the features of the disclosure and by way of a slide valve having the features of the disclosure.

The valve piston according to the disclosure has a first region which is circular-cylindrical without interruptions and a second region which is circular-cylindrical without interruptions, the two regions having identical diameters. In the case of a uniform flow direction of a pressure medium, one region is arranged on the inflow side and one region is arranged on the outflow side. In the case of two different flow directions, each region can be on the inflow side and on the outflow side. In order to control an opening cross section between the two regions, a plurality of continuous longitudinal grooves extend between them. A radial step and a piston neck are therefore dispensed with. Continuous longitudinal webs remain between the continuous longitudinal grooves, which longitudinal webs extend between the two regions. On account of the longitudinal webs, the valve piston can always be guided securely and without tilting in a valve housing independently of its displacement position.

If, in particular, the second region is on the inflow side, the flow through the longitudinal grooves can be optimized if the longitudinal grooves have a first flank adjacently with respect to the first region and a second flank adjacently with respect to the second region, a steepness of the first flank immediately adjacently with respect to the first region being lower than a steepness of the second flank immediately adjacently with respect to the second region.

As viewed in the longitudinal section of the valve piston, in each case one bend is preferably formed at the ends of the longitudinal grooves at the transition of the first region into the first flank and at the transition of the second region into the second flank. The bends are comparable, as viewed functionally, with the control edges of the above-described valve pistons of the prior art.

In one preferred refinement, the steepness of the first flat flank is substantially constant or approximately constant in sections. The steepness of the first flank immediately adjacently with respect to the first region is preferably less than 40 degrees, for example approximately from 20 to 30 degrees.

In one preferred refinement, the steeper second flank is arcuate, as viewed in the longitudinal section of the valve piston, the steepness of the second flank decreasing in a manner which starts from the second region. If the second flank is on the inflow side, a flow which bears against the shape can be achieved by way of said shape, and the risk of cavitation can be reduced.

The steepness of the second flank immediately adjacently with respect to the second region is preferably more than 55 degrees, for example approximately from 65 to 75 degrees. If the second flank is on the inflow side, the risk of cavitation can be minimized by way of the said steepness, and the piston forces are low on account of flow forces, which leads to satisfactory controllability of the position of the valve piston. Furthermore, the development of noise is low.

If first end sections of the various longitudinal grooves, which first end sections are arranged adjacently with respect to the first region, are arranged axially at different points of the valve piston, the precision control is improved if the first region and therefore the first end sections are on the inflow side.

In one preferred development of each longitudinal groove which is simple in terms of manufacturing technology, its first end section and a second end section are in each case arcuate, in a radial view of the valve piston, the longitudinal groove having a main section of constant width between the two end sections. Therefore, the longitudinal grooves have two long edge sections which are parallel to one another and to the longitudinal axis of the valve piston between the end sections. The second end sections can be approximately semicircular.

In order to mutually compensate for the flow forces of the individual longitudinal grooves and thus to reduce the piston forces, the longitudinal grooves are preferably distributed uniformly on the circumference of the valve piston.

In order to realize the flows through the longitudinal grooves in a manner which is as free from disruption as possible, it is preferred if a respective groove bottom of the longitudinal grooves including the respective two flanks has a constant course, as viewed in the longitudinal section of the valve piston.

The steplessly adjustable slide valve according to the disclosure has an above-described valve piston, a first pressure space being provided on the outer circumference of the first region and/or the first flank, whereas a second pressure space is provided on the outer circumference of the second region and/or the second flank. The two pressure spaces are separated from one another by way of a radial constriction which is arranged on the outer circumference of the longitudinal grooves.

The constriction and the second pressure space are configured on a bush which, for reasons of manufacturing and assembly technology, is arranged between the valve piston and the valve housing, and with respect to which the valve piston can be displaced. The valve piston is always guided securely via the longitudinal webs thereof, independently of its displacement position, and does not become jammed with the constriction of the bush.

In order to realize a connection of the second pressure space via the bush radially to the outside to a connector of the valve housing, the bush has a plurality of passage recesses on the outer circumference of the second pressure space, via which passage recesses the second pressure space is connected to an outer pressure space which is formed in the valve housing.

If the first region is arranged on the inflow side, the first flat flank is on the inflow side. The opening cross section of the slide valve is then disproportionate to the displacement travel of the valve piston, since the longitudinal groove is flowed through with a lower depth in the case of a lower displacement travel and the released depth of the longitudinal groove also increases only as the displacement travel increases.

If the second region is arranged on the inflow side, the second steep flank is on the inflow side. The displacement travel of the valve piston is then approximately proportional to the opening cross section of the slide valve, since the longitudinal groove can already be flowed through with a great depth even in the case of a small displacement travel.

In a first application of the slide valve, it is configured as a breakage protection valve, it being possible for the first pressure space to be connected via an operating connector to be secured to an operating line to be secured, whereas the second pressure space can be connected via a pump connector to a pump line. During normal operation, the breakage protection valve is flowed through from the pump connector to the operating connector to be secured and therefore from the second region to the first region. If the operating line to be secured is a pipe, the breakage protection valve can also be called a pipe breakage protection valve.

It is particularly preferred if a check valve function or a check valve is arranged between the operating connector to be secured and the first region, the opening direction of which check valve function or check valve is directed from the first region to the operating connector to be secured. In an emergency, in the case of a pressure drop at the pump connector as a result of a leak of the operating line to be secured, a throughflow from the operating connector to be secured to the pump connector and therefore from the first region to the second region, and an uncontrolled movement, for example downward movement, of a consumer which is connected to the operating connector are therefore first of all automatically prevented.

The check function can be produced in a simple manner in terms of apparatus technology by way of a cone which is configured in the first region of the valve piston and can be set against an edge of the bush and can be raised up from the latter.

In one particularly preferred development of the breakage protection valve, it has a control pressure connector, via which the check function can be canceled, and an opening cross section from the first pressure space to the second pressure space can be opened in a controlled manner via the first end sections of the longitudinal grooves. A controlled movement, for example downward movement, of the consumer is made possible in this way.

In a second application of the slide valve, it is configured as a load-lowering brake valve, it being possible for the first pressure space to be connected, for example, via an operating line to the consumer which bears the load to be braked and which generates a load pressure. Two load-lowering brake valves of this type can be arranged particularly preferably on two cylinders of a boom of an excavator which are to be lowered synchronously. The lowering speed of the boom can be controlled during emergency operation by way of the two load-lowering brake valves.

### BRIEF DESCRIPTION OF THE DRAWINGS

One exemplary embodiment of the valve piston according to the disclosure and a slide valve according to the disclosure are shown in the drawings. The disclosure will now be explained in greater detail using the figures of the said drawings, in which:

FIG. 1 shows a view of the valve piston according to the disclosure in accordance with the exemplary embodiment,

FIG. 2 shows a longitudinal section of a longitudinal groove of the valve piston from FIG. 1,

FIG. 3 shows a longitudinal section of a slide valve having the valve piston from FIG. 1, and

FIG. 4 shows a view of a bush of the slide valve from FIG. 3.

### DETAILED DESCRIPTION

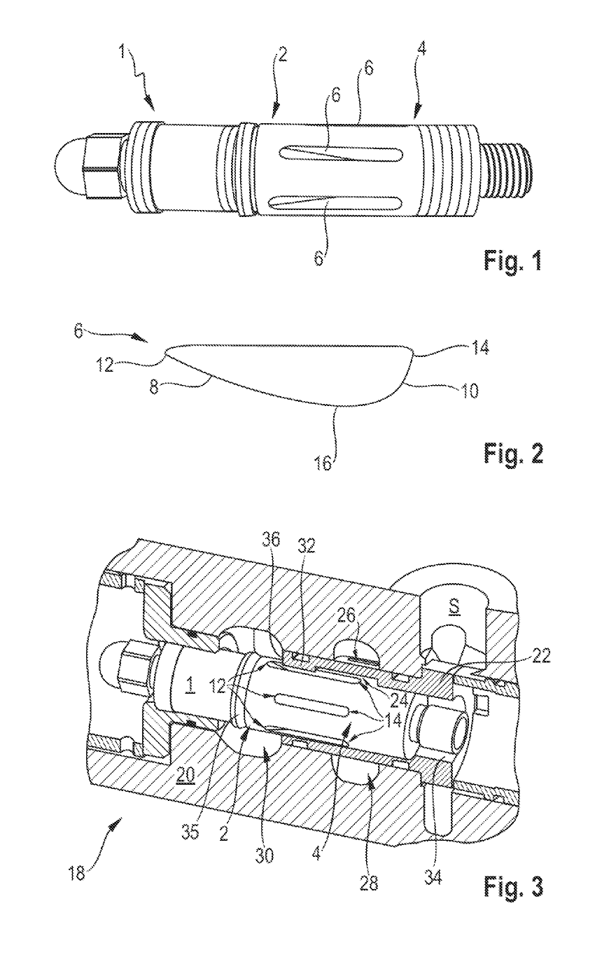

FIG. 1 shows a view of the exemplary embodiment of the valve piston 1 according to the disclosure. It has a circular-cylindrical section with two regions 2, 4 which are spaced apart axially from one another, are both of circular-cylindrical configuration over their complete circumference and have an identical diameter. Five longitudinal grooves 6 are provided uniformly on the circumference of the valve piston 1 between the two regions 2, 4, which longitudinal grooves 6 serve to connect two pressure spaces (not shown in FIG. 1) which are formed on the outer circumference of the two regions 2, 4.

FIG. 2 shows a longitudinal groove 6 in a cross section of the valve piston 1. It can be seen here that its depth starting from the first region 2 increases comparatively slowly, whereas its depth starting from the second region 4 increases comparatively rapidly. This results in a first comparatively flat flank 8 and a second comparatively steep flank 10. The first flank 8 first of all drops approximately constantly in a manner which starts from a first end section 12, whereas the second flank 10 has a decreasing steepness in a manner which starts from a second end section 14, with the result that the second flank is of arcuate design. A likewise constantly rounded middle groove bottom 16 is provided between the two flanks 8, 10.

The steepness of the first flank 8 directly adjacently with respect to the first end section 12 is approximately from 20 to 30 degrees, whereas the steepness of the second flank 10 directly adjacently with respect to the second end section 14 is approximately from 65 to 75 degrees.

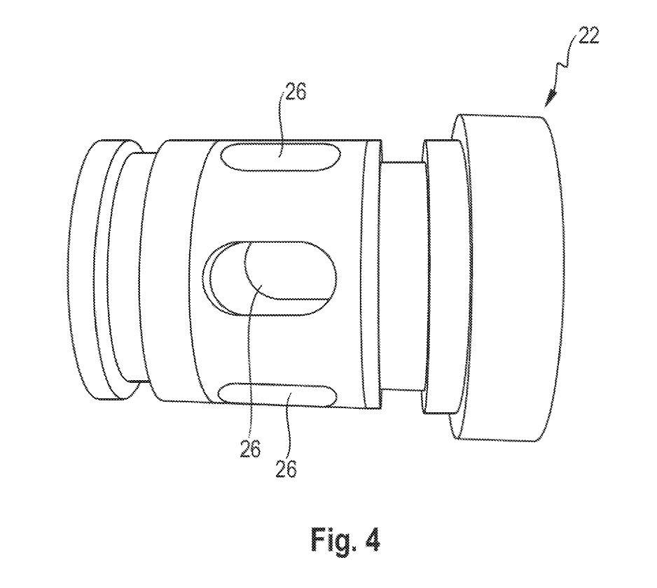

FIG. 3 shows a slide valve 18 according to the disclosure having the valve piston 1 according to FIGS. 1 and 2. The slide valve 18 has a valve housing 20, in the valve bore of which a bush 22 is inserted which covers the second region 14 and at least a large part of the length of the longitudinal grooves 6. A second pressure space 24 is configured in the interior of the bush 22 on the outer circumference of the second region 4, which second pressure space 24 is connected fluidically via radial passage recesses 26 of the bush 22 to an outer pressure space 28.

A first pressure space 30 is configured in the valve housing 20 adjacently with respect to the bush 22 on the outer circumference of the first region 2 of the valve piston 1.

The two pressure spaces 24, 30 are separated from one another by way of a radial constriction 32 which is fixed on the housing and is configured at an end section of the bush 22. Since the second end sections 14 of the longitudinal grooves 6 are at the same location as viewed axially, and since the first end sections 12 of the longitudinal grooves 6 are at different locations as viewed radially, the longitudinal grooves 6 are of different lengths.

FIG. 3 shows a position of the valve piston 1, in which at least the first end sections 12 of the longer longitudinal grooves 6 are not covered by the radial constriction 32, with the result that the slide valve 18 is shown in an at least partially open position.

The first pressure space 30 is connected via a channel to an operating connector (both not shown). The outer pressure space 28 is connected via a channel to a pump connector (both not shown).

Furthermore, the slide valve 18 has a control pressure connector S which is connected to a control pressure space 34 which is delimited by an end-side pressure face of the valve piston 1. The valve piston 1 can be displaced (to the left in FIG. 3) by way of pressure loading of the control pressure connector S with a control pressure, with the result that the first end sections 12 of the longitudinal grooves 6 are pushed out of the cover of the radial constriction 32 into the first pressure space 30, and the slide valve 18 can be opened.

Furthermore, a cone 35 is configured in the interior of the first pressure space 30 adjacently with respect to the first region 2 on the valve piston 1, which cone 35 can be set against an edge 36 of the bush 22, as a result of which a seat valve is formed. If the pressure in the first pressure space 30 is higher than in the second pressure space 24 and therefore in the outer pressure space 28, and if the control pressure at the control pressure connector S is sufficiently lower or is equal to zero, the check valve which is formed in this way closes.

FIG. 4 shows the bush 22 in a side view. Three of the total of five passage recesses 26 can be seen here, via the second pressure space 24 which is formed in the interior of the bush 22 is always connected to the outer pressure space 28 which is formed on its outer circumference.

The slide valve 18 which is shown in FIG. 3 serves as a pipe breakage protection valve. In normal operation, it is flowed through from the pump connector to the operating connector to be secured and therefore from the second pressure space 24 to the first pressure space 30. In the case of a pressure drop at the pump connector and therefore in the second pressure space 24 as a result of a leak of the operating line to be secured, a throughflow from the operating connector to be secured to the pump connector and therefore from the first region to the second region, and an uncontrolled movement of a consumer which is connected to the operating connector are first of all prevented automatically via the check valve. The check valve and the slide valve 18 can then be opened via a loading of the control pressure space 34 with control pressure, and the consumer can be moved in a controlled manner so as to follow the load.

A valve piston and a slide valve having a valve piston of this type are disclosed. The valve piston has a section which is of circular-cylindrical configuration with a constant diameter and in which a plurality of longitudinal grooves which are parallel to one another are made, which longitudinal grooves are distributed uniformly on the circumference. The section of the valve piston can always be moved without tilting in the valve by way of the remaining webs. Each longitudinal groove can have one steeper flank and one less steep flank. The steeper flank can be set against a pressure medium which flows in, as a result of which a seat valve is formed.

### LIST OF REFERENCE NUMERALS

1 Valve piston

2 First region

4 Second region

6 Longitudinal groove

8 First flank

10 Second flank

12 First end section

14 Second end section

16 Middle groove bottom

18 Slide valve

20 Valve housing

22 Bush

24 Second pressure space

26 Passage recess

28 Outer pressure space

30 First pressure space

32 Radial constriction

34 Control pressure space

35 Cone

36 Edge

S Control pressure connector

What is claim is:

1. A valve piston, comprising:
a circular-cylindrical first region;
a circular-cylindrical second region, the two regions having identical diameters; and
a plurality of longitudinal grooves extending between the first region and the second region.

2. The valve piston according to claim 1, wherein:
the longitudinal grooves have a first flank arranged adjacently with respect to the first region and a second flank arranged adjacently with respect to the second region, and
a steepness of the first flank in the immediate vicinity of the first region is lower than a steepness of the second flank in the immediate vicinity of the second region.

3. The valve piston according to claim 2, wherein the steepness of the first flank is approximately constant in the vicinity of the first region.

4. The valve piston according to claim 2, wherein the steepness of the first flank is lower than 40 degrees.

5. The valve piston according to claim 2, wherein the second flank is arcuate, the steepness of the second flank decreasing in a manner that starts from the second region.

6. The valve piston according to claim 2, wherein the steepness of the second flank in the immediate vicinity of the second region is greater than 55 degrees.

7. The valve piston according to claim 1, wherein the longitudinal grooves have first end sections arranged adjacently with respect to the first region and arranged axially at different positions of the valve piston.

8. The valve piston according to claim 7, wherein one or more of (i) the first end section and a second end section are in each case arcuate and (ii) the longitudinal groove has a constant width between the first and second end sections.

9. The valve piston according to claim 1, wherein the longitudinal groove, which includes the two flanks, has a groove bottom that is constant.

10. A slide valve, comprising:
a valve piston including:
a circular-cylindrical first region,
a circular-cylindrical second region, the two regions having identical diameters, and
a plurality of longitudinal grooves extending between the first region and the second region;
a first pressure space arranged on an outer circumference of the first region; and
a second pressure space arranged on an outer circumference of the second region, the first and second pressure spaces separated from one another by a radial constriction formed on the outer circumference of the longitudinal grooves,
wherein the constriction and the second pressure space are configured on a bush that is arranged between the valve piston and a valve housing.

11. The slide valve according to claim 10, wherein the slide valve is configured as a breakage protection valve, the first region configured to be connected to an operating connector to be secured, the second region configured to be connected to a pump connector.

12. The slide valve according to claim 10, further comprising a check valve function arranged between the first pressure space and the first region, wherein an opening direction of the check valve function is directed from the first region to the first pressure space.

13. The slide valve according to claim 10, wherein the slide valve is configured as a load-lowering brake valve, the first region configured to be connected via an operating connector to a consumer.
